(19) United States
(12) Patent Application Publication
(10) Pub. No.: US 2025/0344013 A1
(43) Pub. Date: Nov. 6, 2025

(54) HEADPHONES

(71) Applicant: Sonos, Inc., Goleta, CA (US)

(72) Inventor: Tristan TAYLOR, Boston, MA (US)

(21) Appl. No.: 19/199,814

(22) Filed: May 6, 2025

Related U.S. Application Data
(60) Provisional application No. 63/643,313, filed on May 6, 2024.

(51) Int. Cl. H04R 1/10; H04R 1/02

(52) U.S. Cl. CPC H04R 1/1066; H04R 1/023; H04R 1/1008; H04R 1/105; H04R 1/1083; H04R 2460/01; H04R 2460/15

(57) ABSTRACT

A headphone may include an earcup connected to a first end of a headband via a connecting member, a distal end of the connecting member having a cap. The headphone may include a slider mechanism configured to facilitate adjustment of the earcup relative to the headband. The slider mechanism may include a housing having a channel extending therethrough between an upper end and a lower end thereof. The channel is configured to receive therein at least a portion of the connecting member, including the distal end and the cap. The housing includes at least one rail. A friction shoe is connected to the cap and includes a friction pad that is configured to engage and move along the at least one rail. The engagement between the friction shoe and the at least one rail is configured to at least partially control movement of the connecting member relative to the housing.

### CROSS-REFERENCE TO RELATED APPLICATIONS

This application claims the benefit of and priority to U.S. Provisional Application No. 63/643,313 filed on May 6, 2024, and entitled HEADPHONES, the contents of which are incorporated by reference herein in its entirety.

### FIELD OF THE DISCLOSURE

The disclosure is related to audio playback devices and, more particularly, to systems, methods, features, and other elements directed to headphones.

### BACKGROUND

With ever expanding listening options, including music, podcasts, and audiobooks, the use of audio playback devices has dramatically increased in recent history. Headphones are a particularly popular choice for consuming audio content because they are highly portable. Additionally, headphones allow for users to enjoy a personal listening experience without the audio content bothering or being shared with those around them.

However, with the increased availability and use of headphones, consumers are constantly searching for headphones that provide a more comfortable and higher quality user experience. Accordingly, there continues to be a need to develop headphones that provide an improved user experience.

### BRIEF DESCRIPTION OF THE DRAWINGS

Features, aspects, and advantages of the presently disclosed technology may be better understood concerning the following description, appended claims, and accompanying drawings. A person skilled in the relevant art will understand that the features shown in the drawings are for purposes of illustration, and variations, including different or additional features and arrangements thereof, are possible.

FIG. 1 shows a set of headphones according to an example embodiment.

FIG. 2 shows the set of headphones of FIG. 1 with portions of the headband removed.

FIGS. 3A and 3B illustrate a slider mechanism according to an example embodiment.

FIGS. 4A through 4D illustrate a slider mechanism according to another example embodiment.

FIG. 5 shows a headband frame according to an example embodiment.

FIG. 6 shows a headband frame and a cover plate according to an example embodiment.

FIGS. 7 and 8 show a headband frame and cushions according to an example embodiment.

FIG. 9 shows a headband spring according to an example embodiment.

FIGS. 10-12 show an earcushion according to an example embodiment.

FIG. 13 shows connection components and alignment features for an earcup and an earcushion according to an example embodiment.

FIGS. 14-16 show ports of an earcup according to an example embodiment.

FIG. 17 shows a feedback microphone configuration according to an example embodiment.

The drawings are to illustrate example implementations and are not drawn to scale. It is understood that the inventions are not limited to the arrangements and instrumentalities shown in the drawings.

### DETAILED DESCRIPTION

A better understanding of different embodiments of the disclosure may be had from the following description read with the drawings in which like reference characters refer to like elements.

While the disclosure is susceptible to various modifications and alternative constructions, certain illustrative embodiments are in the drawings and are described below. The dimensions, angles, and curvatures represented are to be understood as examples for purposes of illustration and are not necessarily shown in proportion.

It should be understood, however, there is no intention to limit the disclosure to the specific embodiments disclosed, but on the contrary, the intention covers all modifications, alternative constructions, and equivalents falling within the spirit and scope of the disclosure.

The labels used herein that indicate or suggest particular orientations of components are used for convenience and describe one of many possible configurations.

### Headphone Over View

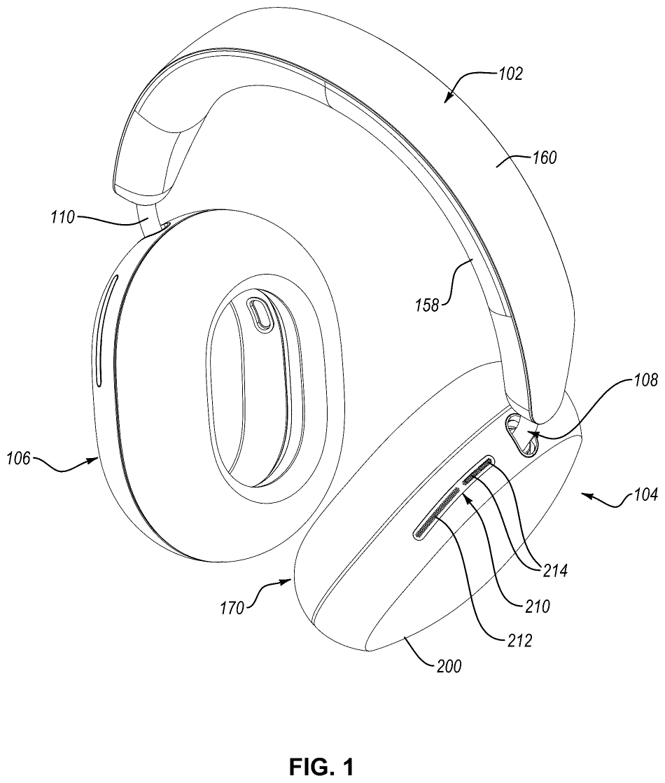

FIG. 1 illustrates an example pair of headphones 100 (also referred to herein as “headphone”). The depicted headphone 100 comprises a headband 102, an earcup 104, and an earcup 106. The headband 102 spans between the two earcups 104, 106 and is connected to the earcups 104, 106 through connecting members 108, 110.

The headphone 100 may comprise one or more transducers within each of the earcups 104, 106. The one or more transducers may comprise speakers and/or microphones. Additionally, the headphone 100 may comprise various other components including, but not limited to, a wireless network interface (e.g., WiFi, Bluetooth, Cellular, etc.), a battery, a user interface, one or more processors, and/or computer-readable storage.

### Headband

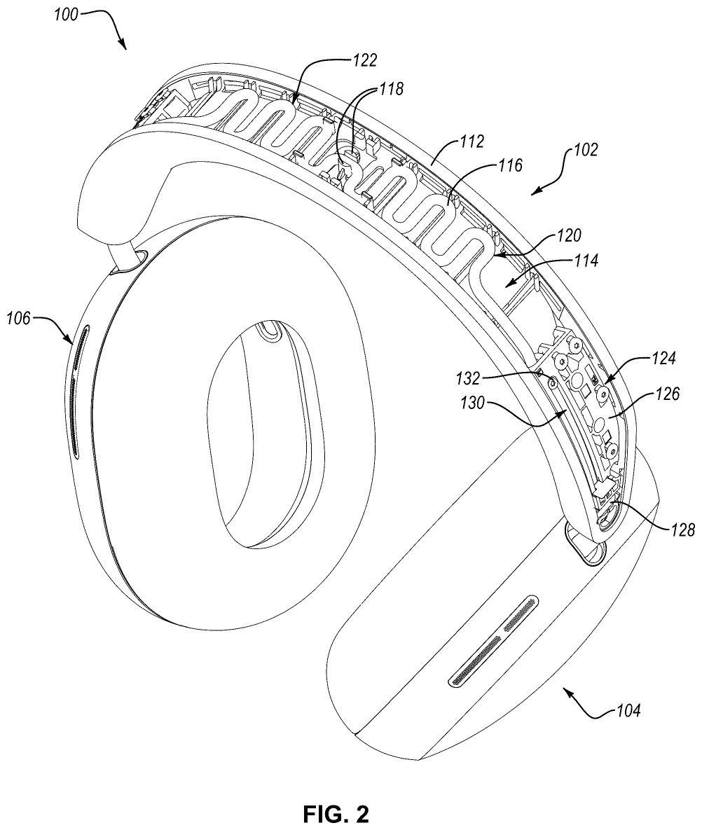

With continued reference to FIG. 1, reference is now also directed to FIGS. 2-8, which illustrate features of the headband 102.

FIG. 2 illustrates the headband 102 with various layers and components removed. As can be seen, the headband 102 includes a frame 112 that provides some of the primary structural aspects to the headband 102. The frame 112 has a curved shape to generally fit over a user's head.

The frame 112 includes a channel 114 in which various components of the headband 102 can be disposed. For instance, as shown in FIG. 2, a cable 116 is disposed within the channel 114. The cable 116 can electrically connect the earcups 104, 106 together to carry electrical power, audio signals, and/or other electrical signals therebetween. In the illustrated embodiment, the middle of the cable 116 is connected to the middle of the frame 112. For instance, the frame 112 includes a retaining feature 118 that secures the middle of the cable 116 in place within the channel 114. The retaining feature 118 may be or include a friction fit feature (e.g., opposing sidewalls that hold the cable 116 therebetween via friction), a clip, adhesive, or any other suitable component or structure capable of holding the middle of the cable 116 in place. In the illustrated embodiment, the retaining feature 118 is disposed in the middle of the frame 112 side-to-side such that the retaining feature 118 is disposed about equidistant from each of the earcups 104, 106. Additionally, the retaining feature 118 is also disposed about midway or centered front-to-back between the front and rear of the frame 112.

Between the retaining feature 118 and each of the connecting members 108, 110, the cable 116 may have a non-linear segment 120, 122. In the illustrated embodiment, the non-linear segments 120, 122 have serpentine configurations, but other configurations are contemplated (sinusoidal, S-shaped, etc.). In some embodiments, the non-linear segments 120, 122 are mirror images of one another. In some embodiments, the portion of the cable 116 that is secured by the retaining feature 118 is offset from maximum amplitudes of the curves in the non-linear segments 120, 122.

The non-linear segments 120, 122 may allow for length of the cable 116 between the retaining feature 118 and the connecting members 108, 110 to selectively expand and contract. For instance, as the earcups 104, 106 are extended relative to the headband 102 (e.g., moved further from the ends of the headband 102 to increase the size of the headphone 100), the length of the cable 116 can expand by at least partially straightening the non-linear segments 120, 122. Conversely, when the earcups 104, 106 are retracted relative to the headband 102 (e.g., moved closer to the ends of the headband 102 to decrease the size of the headphone 100), the length of the cable 116 can be shortened by returning to the non-linear configuration. To facilitate the return to the non-linear configuration, the cable 116 may be formed to have a memory of the non-linear configuration. This may be done by forming the cable 116 from shape memory materials (metals, plastics, etc.) or by heat setting the cable 116 in the non-linear configuration.

FIG. 2 also illustrates a slider mechanism 124 disposed adjacent to an end of the headband 102. The slider mechanism 124 facilitates the extension and retraction of the earcup 104 relative to the headband 102. A similar slider mechanism may also be disposed at the opposite end of the headband 102 to facilitate the extension and retraction of the earcup 106 relative to the headband 102. As can be seen in FIG. 2, the slider mechanism 124 includes a housing 126 that is mounted within the channel 114 of the frame 112. The housing 126 may be secured to the frame 112 with a fastener 128, such as a pin, clip, bolts, screws, adhesive, or other suitable mechanical.

### Slider Mechanisms

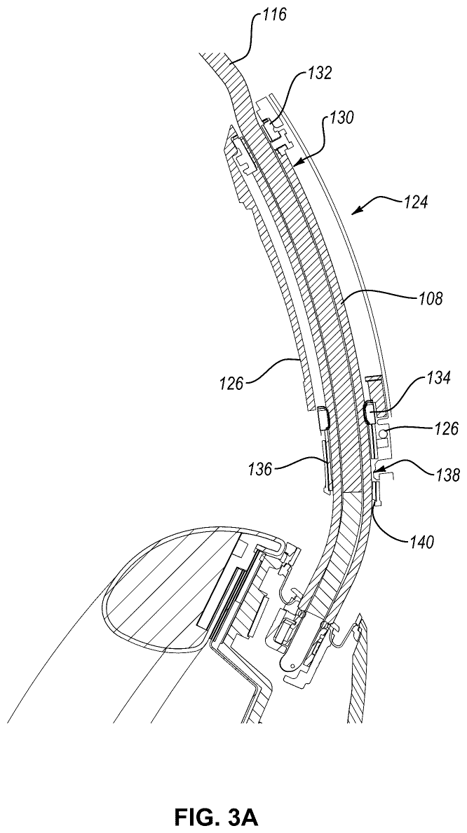

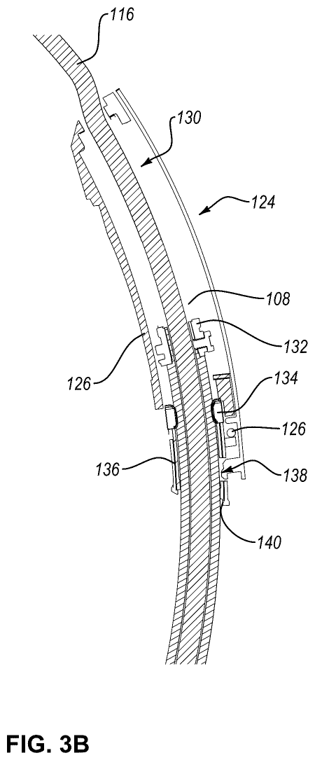

With continued attention to FIG. 2, attention is now also directed to FIGS. 3A and 3B, which illustrate the connecting member 108 and the earcup 104 in retracted and extended positions, respectively, with additional details of the slider mechanism 124 shown. In FIGS. 3A and 3B, the slider mechanism 124 is shown in cross-section. For simplicity, some additional components (e.g., the earcup 104, the cable 116, the connecting member 108) of the headphone 100 have been included, while other components (e.g., the frame 112) have been omitted. Additionally, while the discussion of FIGS. 3A and 3B focus on the slider mechanism 124 associated with the earcup 104, it will be appreciated that the slider mechanism associated with the earcup 106 may be similar to or the same as the slider mechanism 124.

As alluded to above, the earcup 104 can be moved closer to or further from the headband 102 in order to adjust the size of the headphone 100. The slider mechanism 124 facilitates this adjustment. As noted, the slider mechanism 124 includes the housing 126. The housing 126 has a channel 130 extending therethrough. The connecting member 108 extends at least partially into the channel 130 and can slide within the channel 130.

The distal end (e.g., the end furthest from the earcup 104) of the connecting member 108 includes a cap 132. As the connecting member 108 slides through the channel 130, the cap 132 likewise slides through the channel 130 with the connecting member 108. The cap 132 may have an outer shape and/or dimension that generally correspond to the shape and/or inner dimension of the channel 130, such that the cap 132 interfaces with the inner surface of the channel 130 as the cap 132 and connecting member 108 slide through the channel 130. In some embodiments, in contrast, the connecting member 108 may have an outer dimension that is smaller than the outer dimension of the cap 132 and the inner dimension of the channel 130. As a result, the outer surface of the connecting member 108 may not touch or interact with the inner surface of the channel 130. This configuration may reduce the friction associated with sliding the connecting member 108 and the cap 132 through the channel 130.

A grommet 134 may be disposed within the channel 130. In the illustrated embodiment, the grommet 134 is disposed near the lower end of the channel 130 (e.g., the end closest to the earcup 104). The grommet 134 may have a smaller inner dimension than the channel 130 and may engage the outer surface of the connecting member 108. The interface between the grommet 134 and the outer surface of the connecting member 108 may create sufficient friction to hold the connecting member 108 (and the associated earcup 104) in a desired position relative to the headband 102 and prevent the connecting member 108 from undesirably sliding relative to the headband 102. At the same time, the friction between the grommet 134 and the connecting member 108 may be low enough to allow a user to readily overcome the friction in order to adjust the size of the headphone 100 by sliding the connecting member 108 through the grommet 134.

As noted above, the cap 132 may have an outer dimension that is larger than the outer dimension of the connecting member 108. The larger outer dimension of the cap 132 may allow the cap 132 to also function as a stop member. More specifically, the cap 132 may interact with one or more surfaces within the channel 130 to limit the sliding motion of the connecting member 108. For instance, the cap 132 may interact with a shoulder near the upper end of the channel 130 to limit how far the connecting member 108 can be slid into the housing 126. Similarly, the cap 132 may interact with the grommet 134 or a shoulder near the lower end of the channel 130 to limit how far out of the of housing 126 the connecting member 108 can be slid.

The slider mechanism 124 may also include a bushing 136 below the housing 126. The bushing 136 may include a channel 138 therethrough and through which the connecting member 108 can slide. The bushing 136 may have one or more ribs 140 that extend radially inward and interface with the connecting member 108. In some embodiments, the ribs 140 are flexible.

The interfaces between the cap 132 and the interior of the channel 130, the connecting member 108 and the grommet 134, and the connecting member 108 and the ribs 140 of the bushing 136 can provide for desired characteristics. For instance, the noted interfaces can be relatively small, thereby reducing the friction between the components, and thus the amount of force required to adjust the size of the headphone 100. Additionally, having multiple interfaces, and particularly ones that are spread apart, can allow for a very smooth sliding motion between the connecting member 108 and the headband 102. This can provide the headphone 100 with a pleasant user experience and premium feel.

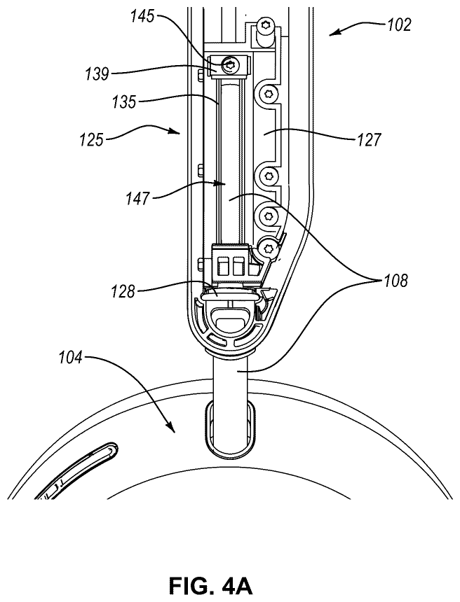

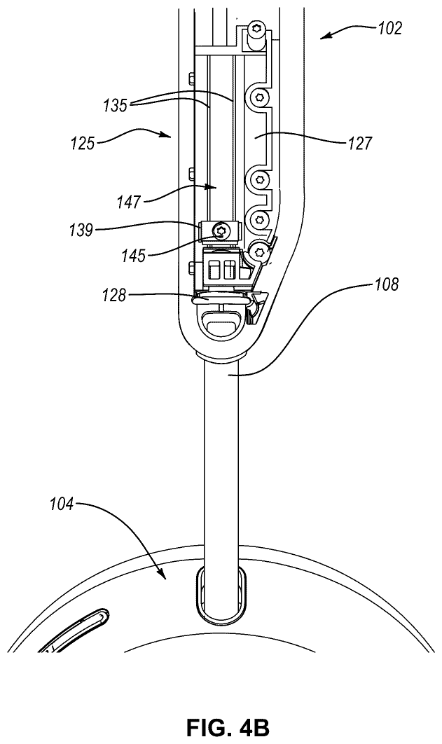

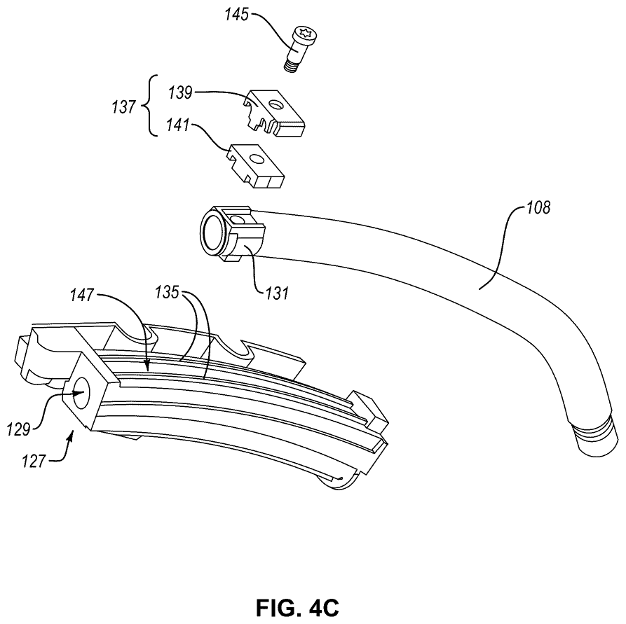

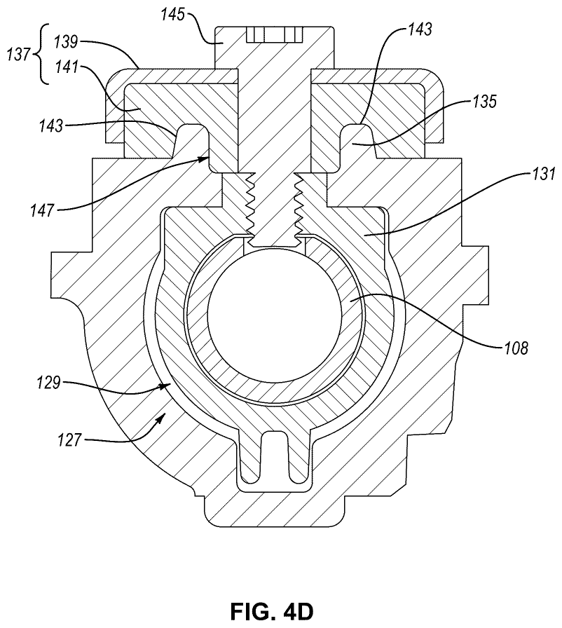

Attention is now directed to FIGS. 4A-4D, which illustrate an alternative embodiment of a slider mechanism that may be used in place of the slider mechanism 124. As with the slider mechanism 124, and as shown in FIGS. 4A and 4B, the slider mechanism 125 is disposed adjacent to an end of the headband 102 and facilitates the extension (FIG. 4B) and retraction (FIG. 4A) of the earcup 104 relative to the headband 102. FIGS. 4C and 4D illustrate an exploded view and a cross-sectional view of the slider mechanism 125. A similar slider mechanism may also be disposed at the opposite end of the headband 102 to facilitate the extension and retraction of the earcup 106 relative to the headband 102.

As can be seen in FIGS. 4A-4C, the slider mechanism 125 includes a housing 127. As shown in FIGS. 4A and 4B, the housing 127 is mounted within the headband 102. The housing 127 may be secured to the headband 102 with a fastener 128, such as a pin, clip, bolts, screws, adhesive, or other suitable mechanical.

As noted above, FIGS. 4A and 4B illustrate the connecting member 108 and the earcup 104 in retracted and extended positions, respectively. As described above, the earcup 104 can be moved closer to or further from the headband 102 in order to adjust the size of the headphone 100. The slider mechanism 125 facilitates this adjustment. The housing 127 of the slider mechanism 125 has a channel 129 extending therethrough. The connecting member 108 extends at least partially into the channel 129 and can slide within the channel 129.

As best seen in FIGS. 4C and 4D, the distal end (e.g., the end furthest from the earcup 104) of the connecting member 108 includes a cap 131. The cap 131 may be connected to the distal end of the connecting member 108 by any suitable means or mechanisms, including laser welding, adhesives, friction fit, interlocking features, fasteners, combinations thereof, and the like.

As can be ascertained by comparing FIGS. 4A and 4B, when the connecting member 108 slides through the channel 129, the cap 131 likewise slides through the channel 129 with the connecting member 108. As can be seen in the cross-section of FIG. 4D, the cap 131 may have an outer shape and/or dimension that generally correspond to the shape and/or inner dimension of the channel 129, such that the cap 131 may interface with the inner surface of the channel 129 as the cap 131 and connecting member 108 slide through the channel 129. In some embodiments, in contrast, the connecting member 108 may have an outer dimension that is smaller than the outer dimension of the cap 131 and the inner dimension of the channel 129. As a result, the outer surface of the connecting member 108 may not touch or interact with the inner surface of the channel 129. This configuration may reduce the friction associated with sliding the connecting member 108 and the cap 131 through the channel 129.

The slider mechanism 125 may also include a friction assembly that is configurated to create sufficient friction to hold the connecting member 108 (and the associated earcup 104) in a desired position relative to the headband 102 and prevent the connecting member 108 from undesirably sliding relative to the headband 102. At the same time, the friction provided by the friction assembly may be low enough to allow a user to readily overcome the friction in order to adjust the size of the headphone 100 by sliding the connecting member 108 and the cap 131 through the channel 129 in the housing 127.

In the illustrated embodiment, the friction assembly includes rails 135 on the housing 127 and a friction shoe 137. The friction shoe 137 includes a frame 139 and a friction pad 141. As best shown in FIG. 4D, the friction pad 141 may include channels 143 that receive the rails 135 therein. As can also be seen, the friction pad 141 may be disposed between the frame 139 and the rails 135. The friction shoe 137 may be configured to slide along the rails 135 when the connecting member 108 is moved relative to the housing 127 to adjust the size of the headphone.

Although the illustrated embodiment includes a housing 127 with two rails 135 and the friction pad 141 includes two corresponding channels 143, this is only one example. In other embodiments, the housing may include one rail or more than two rails. Likewise, the friction pad 141 may include a single channel or more than two channels.

As also best shown in FIG. 4D, the friction shoe 137 may be secured to the cap 131 (and, optionally, to the connecting member 108) with a fastener 145. The fastener 145 may extend through the frame 139, the friction pad 141, and into the cap 131. Securing the friction shoe 137 to the cap 131 may press the friction pad 141 against the rails 135, thereby creating a friction interface between the friction shoe 137 and the rails 135. In some embodiments, the frame 139 may be formed of a relatively rigid or stiff material that is configured to limit or prevent the friction pad 141 from flexing away from the rails 135. In some embodiments, the connection between the fastener 145 and the cap 131 may be selectively adjustable to allow for the level of friction between the friction pad 141 and the rails 135 to be selectively adjusted. For instance, the connection between the fastener 145 and the cap 131 may be a threaded connection.

The housing 127 also includes a slot 147. The slot 147 may extend along at least a portion of the length of the housing 127 and may open into the channel 129 and an exterior of the housing 127. In the illustrated embodiment, the slot 147 is disposed between the rails 135. As shown in FIG. 4D, the slot 147 may be configured to have a portion of the cap 131 and/or the friction pad 141 extend therein and move therethrough. Additionally, the fastener 145 may extend through the slot 147 to connect the friction shoe 137 and the cap 131 together.

In some embodiments, the friction shoe 137 may also function as a stop member. More specifically, the friction shoe 137 may interact with one or more surfaces within the slot 147 to limit the sliding motion of the connecting member 108. For instance, the friction shoe 137 may interact with an end surface of the slot 147 near the upper end of the housing 127 to limit how far the connecting member 108 can be slid into the housing 127. Similarly, the friction shoe 137 may interact with an end surface of the slot 147 near the lower end of the housing 127 to limit how far out of the of housing 127 the connecting member 108 can be slid. In some embodiments, it is the frame 139 of the friction shoe 137 that engages the surfaces of the slot 147 to limit the movement of the connecting member 108 and cap 131. In other embodiments, the cap 131 and/or friction shoe 137 may interact with one or more shoulders on the housing 127 to limit the movement of the connecting member 108.

Similar to the slider mechanism 124, the slider mechanism 125 may also include a bushing 136. The bushing 136 may be similar or identical to that of the slider mechanism 124.

The interfaces between the cap 131 and the interior of the channel 129, the friction shoe 137 and the rails 135, and the connecting member 108 and the ribs 140 of the bushing 136 can provide for desired characteristics. For instance, the noted interfaces can be relatively small, thereby reducing the friction between the components, and thus the amount of force required to adjust the size of the headphone 100. Additionally, having multiple interfaces, and particularly ones that are spread apart, can allow for a very smooth sliding motion between the connecting member 108 and the headband 102. This can provide the headphone 100 with a pleasant user experience and premium feel.

### Headband Flexibility and Comfort

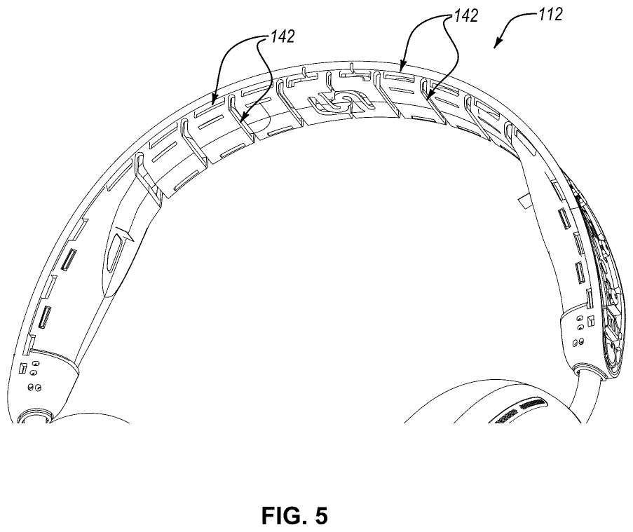

Attention is now directed to FIG. 5, which illustrates another view of the frame 112 of the headband 102. As can be seen, the frame 112 includes a plurality of cutouts 142. Some of the cutouts 142 extend at least partially between the front and rear of the frame 112, while others extend laterally across the portions of the frame 112. The cutouts 142 provide the frame 112 with flexibility. More specifically, because the headphone 100 may be worn by users having different sized heads, the curvature of the headband 102 can be flexible to accommodate such differences. The cutouts 142 allow for the headband 102 to flex larger or smaller without the frame 112 crimping.

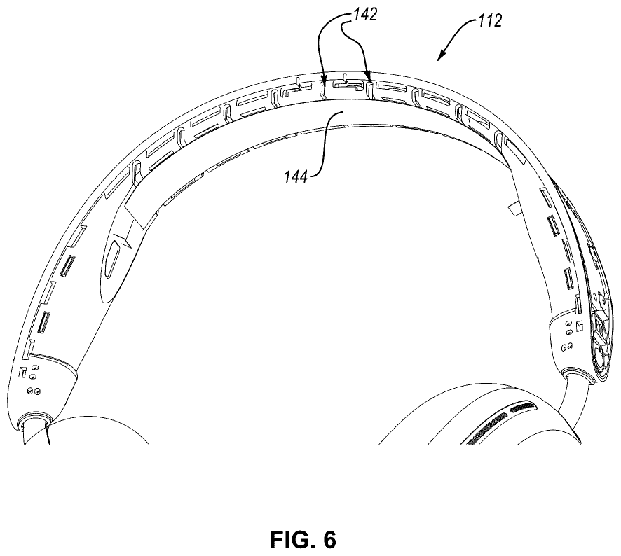

To limit or prevent the cutouts 142 from being felt or seen in the final product (FIG. 1), a cover plate may be positioned to cover all or some of the cutouts 142. For instance, FIG. 6 illustrates an example cover plate 144 that is disposed on the bottom side of the frame 112 and covers portions of the cutouts 142. The cover plate 144 may be formed of any suitable material, such as plastic, metal, or the like. A portion of the cover plate 144 may be attached to the frame 112 while the remainder of the cover plate 144 remain unattached from the frame 112. For instance, a middle region of the cover plate 144 may be attached to the frame 112 (e.g., with a fastener, adhesive, etc.), while the opposing ends of the cover plate 144 are not attached to the frame 112. Connecting only a portion of the cover plate 144 to the frame 112 may allow for the frame 112 to flex without the cover plate 144 hindering such movement.

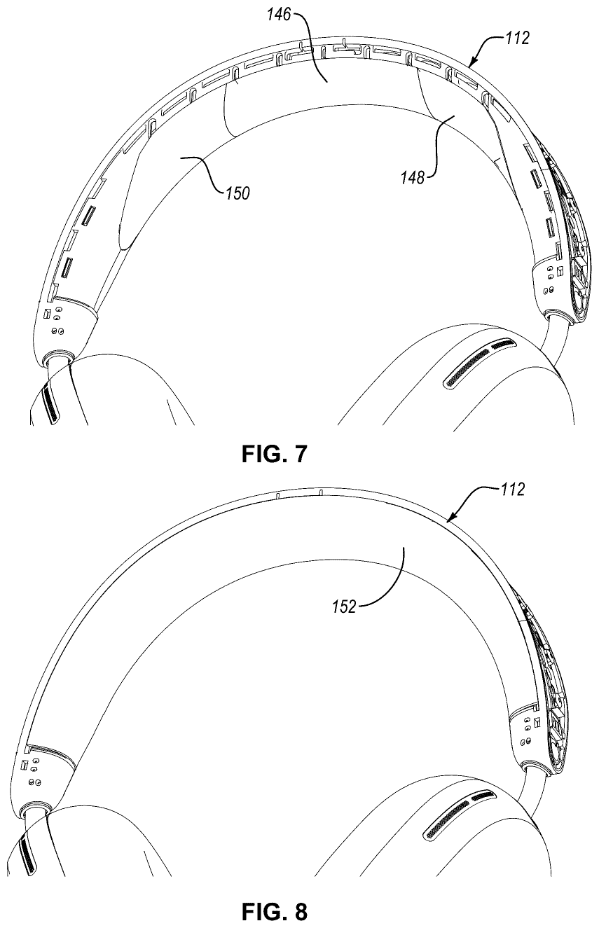

As shown in FIG. 7, the underside of the frame 112 may be at least partially covered with a cushioning material, such as foam. The cushioning material may make the headphone 100 more comfortable to wear. In the illustrated embodiment, there are three cushions 146, 148, 150 attached to the frame 112. The cushion 146 covers the center region of the frame 112, while the cushions 148, 150 are disposed on opposite sides of the cushion 146. In some embodiments, the cushion 146 is formed of a softer material (e.g., open cell foam) than the cushions 148, 150. This may be desirable as the tops of people's head are more sensitive, while the sides are less sensitive and can more comfortably carry the weight of the headphone 100.

The cushions 146, 148, 150 and additional portions of the frame 112 can be covered by an additional cushion 152, as shown in FIG. 8. The cushion 152 may be a relatively thin (e.g., 1 mm, 2 mm, 3 mm, 4 mm, 5 mm) layer of foam. The cushion 152 may soften or smooth out the transitions between the frame 112 and cushions 146, 148, 150, so that the transitions are not or are less visible in the final product (FIG. 1).

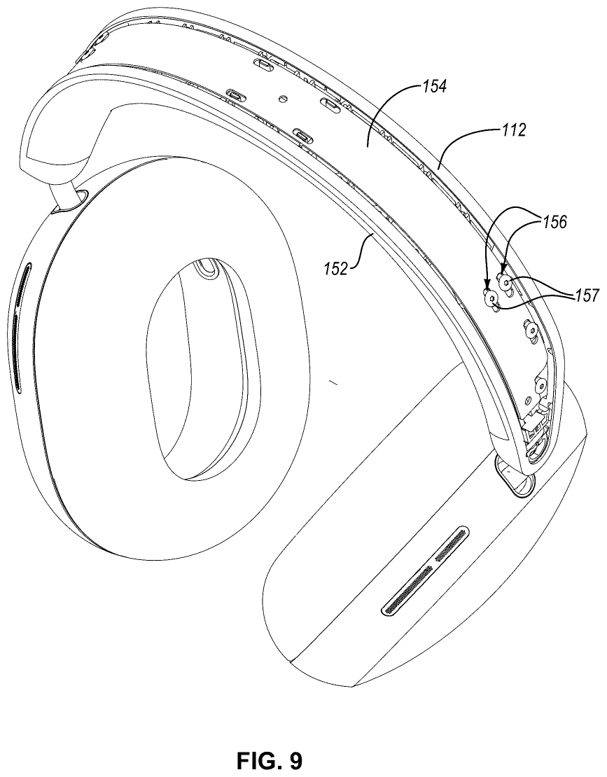

FIG. 9 illustrates a headband spring 154 disposed within the channel 114 of the frame 112. The headband spring 154 can be formed of a metal or semirigid plastic. The headband spring 154 can provide additional structure to the headband 102 and can control the clamping force of the headphone 100 (e.g., how tightly they hold onto a user's head). The headband spring 154 can include slots 156 therethrough. The slots 156 can receive fasteners 157 (e.g., screws, bolts, pins, etc.) that connect the headband spring 154 to the frame 112. The slots 156 may allow for relative movement between the headband spring 154 and the fasteners 157/frame 112 as the headband 102 flexes.

As shown in FIG. 1, the headband 102 may also include one or more outer covers 158, 160. The cover 158 may be a pliable material (e.g., leather, fabric, polyurethane, etc.) that is comfortable in contact with a user's head. The cover 160 may similarly be made of a pliable material. Alternatively, the cover 160 may be a more rigid material, such as plastic or metal.

### Earcushions and Earcups

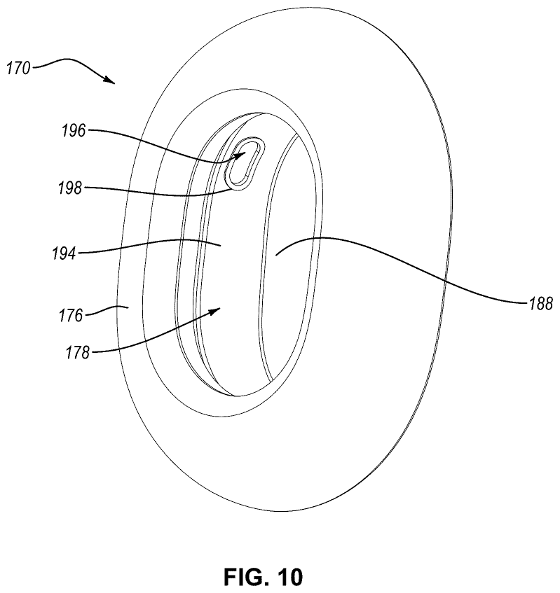

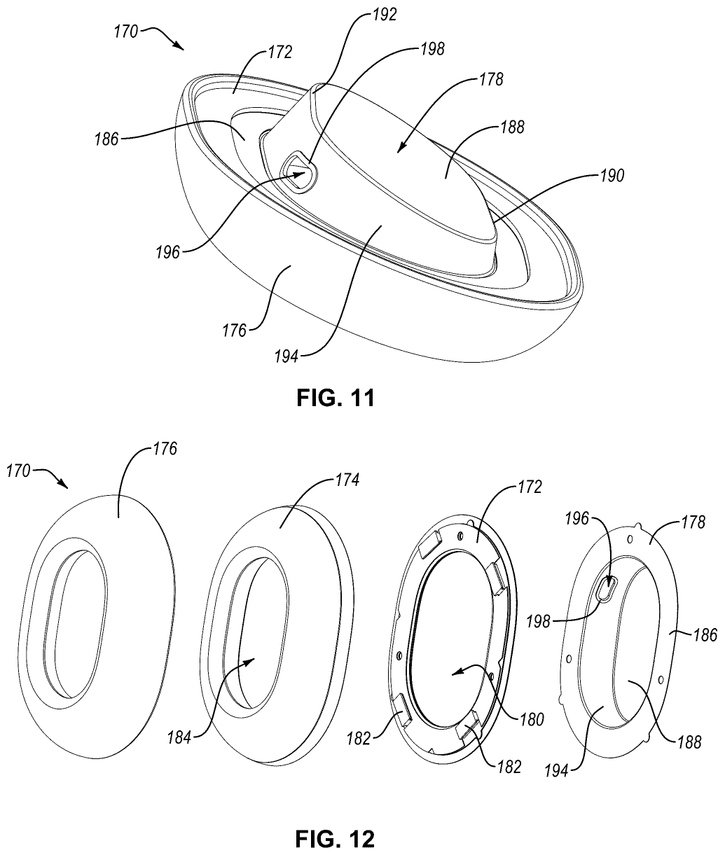

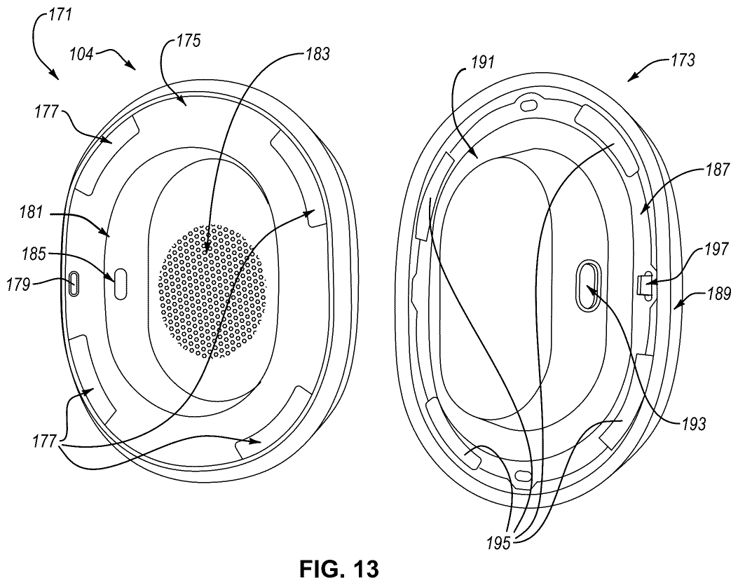

Attention is now directed to FIGS. 10-12, which illustrate aspects of an earcushion 170 of headphone 100. The illustrated earcushion 170 may be part of earcup 104 (FIG. 1). It will be appreciated that earcup 106 may include a similar or identical earcushion. FIGS. 10 and 11 illustrate different perspective views of the earcushion 170 and FIG. 12 illustrates a partially exploded view thereof. Generally, the earcushion 170 includes a frame assembly 172, a cushion 174, a cover 176, and a mesh cage 178.

The frame assembly 172 provides much of the structure to the earcushion 170. The frame assembly 172 has a generally oval or obround shape, although other shapes are contemplated herein. The frame assembly 172 has an aperture 180 extending therethrough. The frame assembly 172 also comprises one or more connection elements 182 that may be used to connect the earcushion 170 to the rest of the earcup 104. In the illustrated embodiment, the one or more connection elements 182 comprise magnets. However, in other embodiments, the connection elements 182 may include any other suitable structures (e.g., hooks, dovetails, clips, etc.) for connecting the earcushion 170 to the rest of the earcup 104.

The cushion 174 is positioned on the side of the frame assembly 172 that faces the user's head. As with the frame assembly 172, the cushion 174 has a generally oval or obround shape with an aperture 184 extending therethrough. The apertures 180, 184 may be generally aligned with one another. The cushion 174 may provide a level of comfort when the headphone 100 is worn by the user. The cushion 174 may be made from a variety of materials, including foams. In one embodiment, the cushion 174 is formed from a CFNT foam.

The cover 176 covers the cushion 174 and at least part of the frame assembly 172. The cover 176 may be formed of fabric, leather, polyurethane, or the like. In some embodiments, the cover 176 is formed of the same material as the cover 158.

The mesh cage 178 may be connected to the frame assembly 172. The mesh cage 178 is primarily designed to act as a cover for the components (e.g., transducers, batteries, etc.) within the earcup 104. For instance, the mesh cage 178 can cover the internal components of the earcup 104 so they are not seen through the apertures 180, 184. Additionally, the mesh cage 178 can also limit or prevent water, dust, or debris from entering the interior of the earcup 104.

In some embodiments, the mesh cage 178 is formed of a mesh material that is thermoformed into the desired shape. The mesh may be flexible and resilient such that it can be moved and return to its preformed shape. Additionally, the mesh may be substantially transparent to sound waves, such that sound from a transducer in the earcup 104 can pass through the mesh with minimal distortion or degradation.

As can be seen in FIG. 12, the mesh cage 178 includes a generally planar portion 186 that attaches to the frame assembly 172. The generally planar portion 186 has a generally oval or obround shape. The mesh cage 178 also includes a recessed portion that is defined by a second generally planar portion 188 and a wall 194. The wall 194 extends between and connects the generally planar portion 186 and the second generally planar portion 188.

The second generally planar portion 188 is offset from the generally planar portion 186. Additionally, the second generally planar portion 188 is oriented within a plane that is non-parallel to the generally planar portion 186. As a result, a first part 190 of the second generally planar portion 188 is positioned closer to the generally planar portion 186 than a second part 192 of the second generally planar portion 188. The angled orientation of the second generally planar portion 188 relative to the generally planar portion 186 may provide additional room within the earcup 104 for electrical components without having to increase the overall size of the earcup 104.

In the illustrated embodiment, the mesh cage 178 includes an opening 196 therethrough. The opening may have a frame 198 about a perimeter thereof. In the illustrated embodiment, the opening is formed in the wall 194. However, the opening may alternatively be formed in the second generally planar portion 188. The opening 196 may provide for a clear line of sight for an infrared sensor in the earcup 104. The infrared sensor may detect when the earcup 104 is properly positioned on a user's ear.

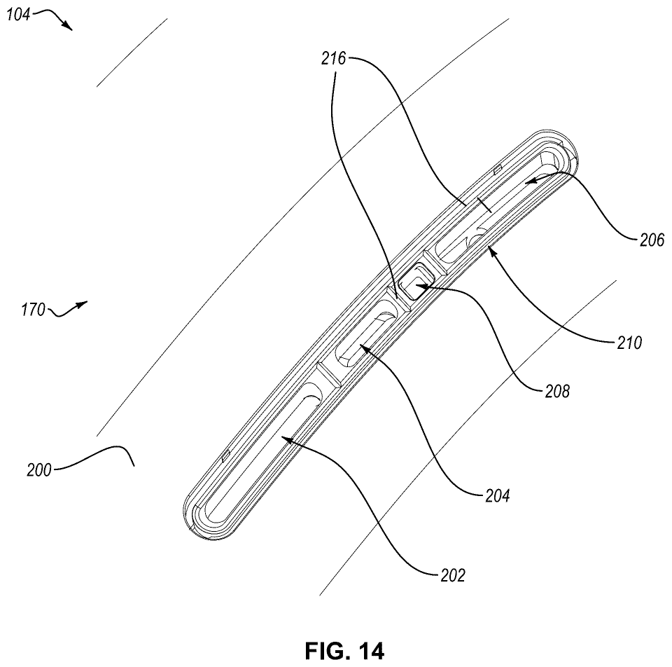

Attention is now directed to FIG. 13, which illustrates another embodiment of an earcup 171 and an earcushion 173. The earcup 171 and earcushion 173 may be the same as or substantially similar to the earcup 104 and earcushion 170 in many respects. Accordingly, the following description will focus on aspects of the earcup 171 and earcushion 173 that may be different from the earcup 104 and earcushion 170.

In the illustrated embodiment, the earcup 171 includes a mounting portion 175 to which the earcushion 173 may be selecting mounted. The mounting portion 175 may have a generally oval or obround shape, although other shapes are contemplated herein. The mounting portion 175 includes one or more connection elements 177. Additionally, the mounting portion also includes one or more alignment features 179. The connection elements 177 and alignment features 179 will be discussed in greater detail below.

The earcup 171 also includes an ear receiving recess 181 that is recessed from the mounting portion 175. The ear receiving recess 181 may be sized and shaped to receive at least a portion of a user's ear therein during use. Within the ear receiving recess 181 is an output 183 for a transducer. An infrared sensor 185 is also disposed within the ear receiving recess 181.

The earcushion 173 includes a frame assembly 187, a cushion 189, and a mesh cage 191. The mesh cage 191 may be substantially the same as the mesh cage 178, including the overall shape and the inclusion of an aperture 193 therein. The shape of the ear receiving recess 181 may generally correspond to the shape of the mesh cage 191, such that the mesh cage 191 can nest within the ear receiving recess 181. When the mesh cage 191 is properly nested within the ear receiving recess 181, the aperture 193 may be aligned with the infrared sensor 185, to allow the infrared sensor 185 to see into the ear receiving recess 181 to detect whether a user's ear is present.

The frame assembly 187 includes one or more connection elements 195 and one or more alignment features 197. The one or more connection elements 195 and the one or more alignment features 197 are configured cooperate with the one or more connection elements 177 and the one or more alignment features 179 to property align and connect the earcushion 173 to the earcup 171.

For instance, in one embodiment, the one or more connection elements 177 and the one or more connection elements 195 may each include a plurality of magnets. The plurality of magnets of the connection elements 177 may be spaced apart and disposed around at least a portion of the mounting portion 175. Similarly, the plurality of magnets of the connection elements 195 may be spaced apart and disposed around at least a portion of the frame assembly 187.

The pluralities of magnets may be positioned and/or oriented so that the earcushion 173 may only be connected to the earcup 171 in one orientation. For instance, the plurality of magnets of the connection elements 177 may include three magnets oriented with their north poles towards the earcushion 173 and one magnet with its south pole oriented towards the earcushion 173. In contrast, the plurality of magnets of the connection elements 195 may include three magnets oriented with their south poles towards the earcup 171 and one magnet with its north pole oriented towards the earcup 171. When properly aligned, the three sets of magnets with opposite polarities (i.e., the three-south pole-oriented magnets and the three north pole-oriented magnets) and the single set of magnets with a different opposite polarity (i.e., the one north pole-oriented magnet and the one south pole-oriented magnet) will attract the earcushion 173 and the earcup 171 together.

On the other hand, if, for example, the earcushion 173 was rotated 180 degrees (so its top and bottom were inverted), at least some of the magnets from the frame assembly 187 would be aligned with magnets from the mounting portion 175 that have the same polarities facing each other. As a result, those set of magnets would repel each other and prevent the earcushion 173 from being connected to the earcup 171. This would indicate to the user that the orientation of the earcushion 173 would need to be changed.

While magnets may be used as the connection components, this is only an example. In other embodiments, any other suitable connection components that are orientation specific may be used. Such orientation specific connection components may also include hook and loop fasteners.

In addition to or as an alternative to using orientation specific connection elements, the connection elements may be spaced apart and in configurations that only allow for connections to be made when the earcushion 173 is properly aligned with the earcup 171. Merely by way of example, the connection elements 177, 195 may be arranged in a pattern that is not symmetrical about a rotational axis. Thus, the connection elements 195 would only align with the connection elements 177 when the earcushion 173 was oriented at one specific orientation. If the earcushion 173 was rotated, 180 degrees, for example, the connection elements 195 would no longer align with the connection elements 177, thereby preventing the earcushion 173 from connecting to the earcup 171.

Using orientation specific connection components and/or arrangements that only allow the earcushion 173 to be connected to the earcup 171 in one orientation may provide various benefits. For instance, only allowing the earcushion 173 to be connected to the earcup 171 in one orientation may ensure that the mesh cage 191 properly nests within the ear receiving recess 181 without being deformed. Additionally, only allowing the earcushion 173 to be connected to the earcup 171 in one orientation may help ensure proper alignment of the aperture 193 with the infrared sensor 185.

The alignment features 179, 197 may also help ensure that the earcushion 173 and the earcup 171 are connected together in the proper orientation and aligned with each other. In the illustrated embodiment, the alignment feature 179 comprises a recess in the mounting portion 175 and the alignment feature 197 comprises a protrusion on the frame assembly 187. When the earcushion 173 is properly oriented and connected to the earcup 171, the protrusion will be received within the recess. In contrast, if the earcushion 173 is not properly aligned with the earcup 171 (e.g., because the earcushion 173 is inverted), then the protrusion will engage the mounting portion 175 away from the recess. As a result, the protrusion will hold the earcushion 173 away from the earcup 171, thereby indicating to the user that the earcushion 173 is not properly aligned or attached to the earcup 171.

In some embodiments, the protrusion may be large enough to hold the frame assembly 187 far enough away from the mounting portion 175 to prevent at least some of the connection elements 177, 195 from connecting to one another. This will provide the user with another indication that the orientation of the earcushion 173 relative to the earcup 171 is not proper.

### Earcup Ports

Attention is again directed to FIG. 1 as well as to FIGS. 14-16. The earcups 104, 106 includes various ports to allow for air and sound waves to travel into and out of the earcups 104, 106 other than through the earcushions. For instance, the earcup 104 may include a housing 200 having a rear leak port 202, a front leak port 204, a first microphone port 206, and a second microphone port 208. It will be appreciated that the specific number, types, ordering/arrangement of the illustrated ports is merely an example. Other embodiments with different numbers, types, and ordering/arrangements of ports are contemplated herein. It will also be appreciated that earcup 106 may include the same, similar, or different ports, or no parts at all.

The rear leak port 202 may be in communication with a rear cavity behind a transducer diaphragm within the earcup 104. Similarly, the front leak port 204 may be in fluid communication with a front cavity in front of the transducer diaphragm. The rear leak port 202 and the front leak port 204 may allow some of the air within the rear and front cavities to escape therefrom as the transducer diaphragm vibrates to produce sound. The inclusion of the rear and front leak ports 202, 204 may allow for the transducer diaphragm to vibrate more freely or to higher amplitudes without having to increase the power supplied to the transducer as would be required without the leak ports.

The first microphone port 206 and the second microphone port 208 may each be in communication with one or more microphones within the earcup 104. For instance, the first microphone port 206 may be in communication with a telephony microphone within the earcup 104. Speech or other sound from the user may be conveyed through the first microphone port 206 to the telephony microphone, thereby enabling a user to communicate via the headphone 100. The second microphone port 208 may be in communication with one or more active noise canceling (“ANC”) microphones within the earcup 104. The ANC microphone(s) may detect background noise in the environment around the headphone 100 and the headphone 100 may be configured to produce opposite sound waves to reduce the amount of background noise the user hears.

In order to provide the earcup 104 with a sleek or minimalist aesthetic, the ports 202, 204, 206, 208 may be arranged together within a common recess 210 in the housing 200. The relatively close arrangement of the ports 202, 204, 206, 208 within the common recess 210 can allow for a single decorative cover 212 to be used to cover all of the ports 202, 204, 206, 208, as shown in FIG. 1.

As can be seen, the cover 212 may substantially fill the recess 210 and may have an outer surface that is substantially flush with the outer surface of the housing 200. Additionally, the cover 212 includes a plurality of apertures 214 extending therethrough that allows for air and/or sound waves to pass through the cover 212 and into or out of the ports 202, 204, 206, 208. The cover 212 may be connected to the housing 200 in any suitable manner, including sonic welding, adhesives, mechanical fasteners, friction fit, or combinations thereof.

As can be seen in FIG. 14, the recess 210 may include one or more surface features 216 that extend around the ports 202, 204, 206, 208. In the illustrated embodiment, the surface feature 216 includes a generally triangular shaped ridge, although other shapes are also contemplated.

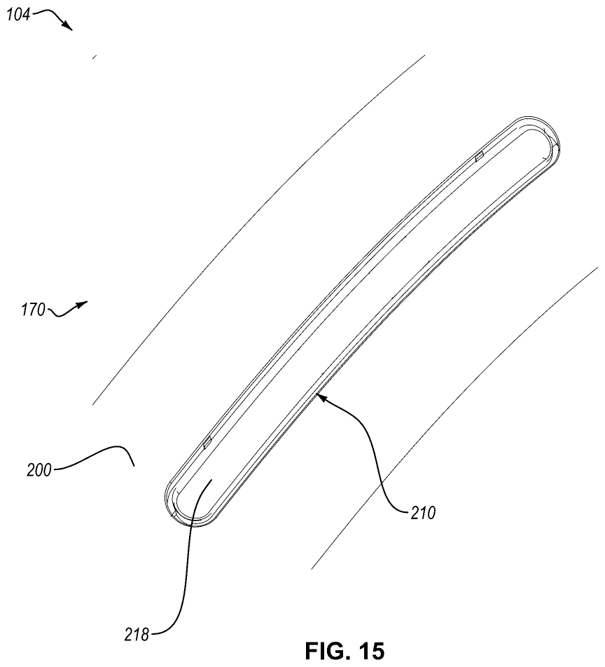

The surface features 216 may be used to secure a mesh layer 218 over the ports 202, 204, 206, 208, as shown in FIG. 15. For instance, the mesh layer 218 may be laid over the ports 202, 204, 206, 208 and the surface features 216. The mesh layer 218 may be secured to the surface features 216 in any suitable manner, such as heat welding, sonic welding, adhesives, mechanical fasteners, or combinations thereof.

The mesh layer 218 may perform multiple functions. For instance, the mesh layer 218 may limit or prevent debris from entering into the ports 202, 204, 206, 208. The mesh layer 218 may also dampen air turbulence around the ports 202, 204, 206, 208. For instance, without the mesh layer 218, air moving over the recess 210 and the ports 202, 204, 206, 208 may create turbulence, which could negatively affect the sound detected by the microphone(s) with the headphone 100. The mesh layer 218, however, can smooth out the flow of air over the ports 202, 204, 206, 208, thereby reducing the turbulence and limiting or avoiding the negative effects of the air movement. To facilitate this functionality of the mesh layer 218, the mesh layer 218 may be positioned relatively close (e.g., less than 1 mm, less than 2 mm, less than 3 mm, etc.) to the outer surface of the housing 200.

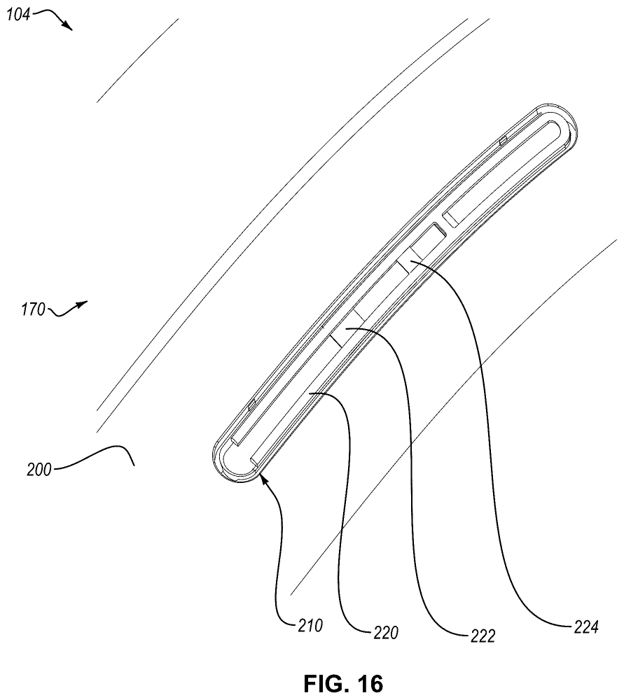

As shown in FIG. 16, one or more gaskets may be used to at least partially isolate all or some of the ports 202, 204, 206, 208 from one another. For instance, a gasket 220 may extend around substantially the entire (or the entire) group of ports 202, 204, 206, 208. Additionally, the gasket 220 may extend between two or more of the ports 202, 204, 206, 208. In the illustrated embodiment, the gasket 220 extends between the first microphone port 206 and the second microphone port 208, such that the first microphone port 206 is entirely surrounded by the gasket 220. Similarly, the gasket 220 or one or more other gaskets (e.g., gaskets 222, 224) may extend between the other ports 202, 204, 206.

Isolating the ports 202, 204, 206, 208 from one another may reduce interference therebetween. For instance, isolating the first microphone port 206 from the front and rear ports 202, 204 may prevent or reduce the likelihood of air or sound waves exiting the ports 202, 204 from entering the first microphone port 206 and creating a feedback loop. Similarly, isolating the second microphone port 208 from the front and rear ports 202, 204 may prevent or reduce the likelihood of air or sound waves exiting the ports 202, 204 from entering the second microphone port 208 and the amount of noise canceling the headphone 100 has to do as a result.

In some embodiments, the gaskets 220, 222, 224 may be cure in place gaskets. Alternatively, the gaskets 220, 222, 224 may be pre-formed and positioned as desired. In some cases, the cover 212 helps hold the gaskets 220, 222, 224 in place. In some embodiments, the gaskets 220, 222, 224 may be positioned over the one or more surface features 216. In other embodiments, the gaskets 220, 222, 224 may be positioned between the surface features 216 and the ports 202, 204, 206, 208.

As noted above, the earcups 104, 106 may include one or more microphones for use in active noise cancellation. In some embodiments, such microphones may include one or more feedforward microphones and one or more feedback microphones. In the earcup 104, the feedforward microphone(s) may be in communication with the second microphone port 208. The feedforward microphone(s) may detect environmental sound outside of the earcup 104 that is desirable to reduce or eliminate for the user. The feedback microphone(s) may detect sound within the earcup 104, such as the sounds adjacent to the user's ear.

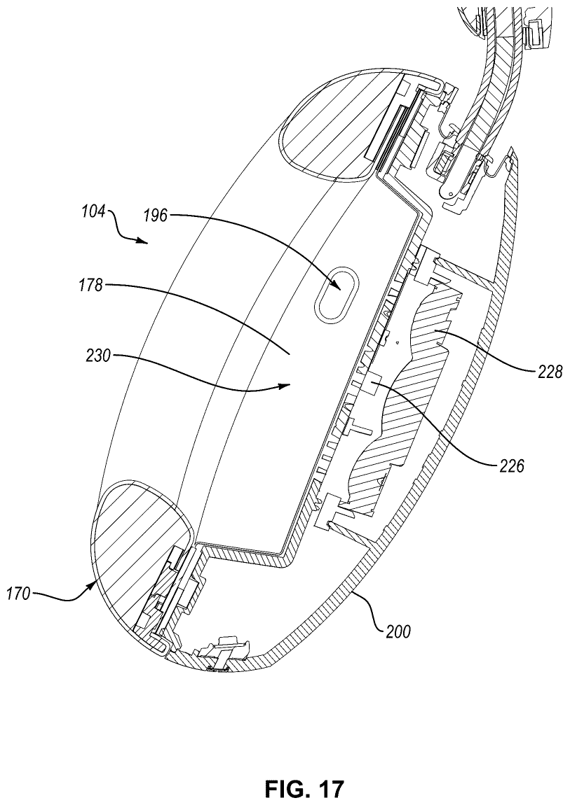

FIG. 17 illustrates one example embodiment of a feedback microphone 226. The placement of the feedback microphone 226 is the illustrated embodiment is unique. Specifically, the feedback microphone 226 is placed in front of the center of a transducer 228 that produces the sound for the user. In the illustrated embodiment, the user's ear fits within a cavity 230 within the earcushion 170. As a result, the feedback microphone 226 is placed directly between the transducer 228 and the user's ear. The feedback microphone 226 can, therefore, detect the sound produced by the transducer 228 and feed that sound back to an active noise cancellation control module, which can further refine the active noise cancellation.

### Example Embodiments

Embodiment 1. A headphone comprising: a headband; an earcup connected to a first end of the headband via a connecting member, a distal end of the connecting member having a cap; and a slider mechanism configured to facilitate adjustment of the earcup relative to the headband, the slider mechanism comprising: a housing having a channel extending therethrough between an upper end and a lower end thereof, the channel being configured to receive therein at least a portion of the connecting member, including the distal end and the cap, the housing comprising at least one rail; and a friction shoe connected to the cap, the friction shoe comprising a friction pad that is configured to engage and move along the at least one rail, the engagement between the friction shoe and the at least one rail being configured to at least partially control movement of the connecting member relative to the housing.

Embodiment 2. The headphone of embodiment 1, wherein the friction shoe and/or the cap is configured to interact with one or more structural features within the housing to limit the movement of the connecting member relative to the housing.

Embodiment 3. The headphone of embodiment 2, wherein the one or more structural features comprise an end of a slot formed in the housing, the end of the slot being disposed adjacent to the upper end of the housing, the end of the slot being configured to interact with the friction shoe and/or the cap to limit how far the connecting member can be slid into the housing.

Embodiment 4. The headphone of embodiment 3 or 4, wherein the one or more structural features comprise a second end of the slot adjacent to the lower end of the housing, the second end of the slot being configured to interact with the friction shoe and/or the cap to limit how far out of the housing the connecting member can be slid.

Embodiment 5. The headphone of any of embodiments 1-4, wherein the cap has an exterior surface that is configured to engage an interior surface of the channel to stabilize movement of the connecting member relative to the housing.

Embodiment 6. The headphone of embodiment 5, wherein the exterior surface of the cap has an outer shape and/or a dimension that generally corresponds to a shape and/or inner dimension of the channel.

Embodiment 7. The headphone of any of embodiments 1-6, wherein the housing further comprises a slot that opens to the channel and an exterior of the housing.

Embodiment 8. The headphone of embodiment 7, wherein the at least one rail comprises a first rail disposed on a first side of the slot and a second rail disposed on an opposing second side of the slot.

Embodiment 9. The headphone of embodiment 8, wherein the first and second rails are on the exterior of the housing.

Embodiment 10. The headphone of any of embodiments 7-9, wherein a portion of the cap extends into the slot.

Embodiment 11. The headphone of any of embodiments 7-10, wherein a portion of the friction shoe extends into the slot.

Embodiment 12. The headphone of any of embodiments 7-11, wherein the friction shoe is connected to the cap by a fastener that extends through the slot.

Embodiment 13. The headphone of embodiment 12, wherein the fastener also connects to the connecting member.

Embodiment 14. The headphone of any of embodiments 1-13, wherein the friction shoe comprises a frame that is configured to press the friction pad against the at least one rail.

Embodiment 15. The headphone of any of embodiments 1-14, wherein the friction pad comprises at least one channel configured to receive the at least one rail therein.

Embodiment 16. A headphone comprising: a headband; an earcup connected to a first end of the headband via a connecting member, a distal end of the connecting member having a cap; and a slider mechanism configured to facilitate adjustment of the earcup relative to the headband, the slider mechanism comprising: a housing comprising: a channel extending therethrough between an upper end and a lower end thereof, the channel being configured to receive therein at least a portion of the connecting member, including the distal end and the cap; a slot that opens to the channel and an exterior of the housing; and first and second rail disposed on opposing sides of the slot; and a friction shoe connected to the cap, the friction shoe comprising a friction pad that is configured to engage and move along the first and second rails, the engagement between the friction shoe and the first and second rails being configured to at least partially control movement of the connecting member relative to the housing.

Embodiment 17. The headphone of embodiment 16, wherein the friction shoe is disposed primarily outside of the housing.

Embodiment 18. A headphone comprising: an earcup comprising: a mounting portion having one or more connection elements and one or more alignment features; and an ear receiving recess having a transducer output and an infrared sensor; and an earcushion comprising: a frame assembly having one or more connection elements and one or more alignment features; and a mesh cage configured to nest within the ear receiving recess, the mesh cage having an aperture configured to aligned with the infrared sensor, wherein the one or more connection elements and one or more alignment features of the mounting portion and the frame assembly are configured to allow for the earcushion to be connected to the earcup in only one orientation.

Embodiment 19. The headphone of embodiment 18, wherein the one or more connection elements of the mounting portion and the frame assembly: comprise orientation specific connection components; and/or are arranged in a non-symmetrical manner about a rotational axis.

Embodiment 20. The headphone of embodiment 18 or 19, wherein the one or more alignment features of the mounting portion and the frame assembly comprise a recess and a protrusion.

### CONCLUSION

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

1. A headphone comprising:
a headband;
an earcup connected to a first end of the headband via a connecting member, a distal end of the connecting member having a cap; and
a slider mechanism configured to facilitate adjustment of the earcup relative to the headband, the slider mechanism comprising:
a housing having a channel extending therethrough between an upper end and a lower end thereof, the channel being configured to receive therein at least a portion of the connecting member, including the distal end and the cap, the housing comprising at least one rail; and
a friction shoe connected to the cap, the friction shoe comprising a friction pad that is configured to engage and move along the at least one rail, the engagement between the friction shoe and the at least one rail being configured to at least partially control movement of the connecting member relative to the housing.

2. The headphone of claim 1, wherein the friction shoe and/or the cap is configured to interact with one or more structural features within the housing to limit the movement of the connecting member relative to the housing.

3. The headphone of claim 2, wherein the one or more structural features comprise an end of a slot formed in the housing, the end of the slot being disposed adjacent to the upper end of the housing, the end of the slot being configured to interact with the friction shoe and/or the cap to limit how far the connecting member can be slid into the housing.

4. The headphone of claim 3, wherein the one or more structural features comprise a second end of the slot adjacent to the lower end of the housing, the second end of the slot being configured to interact with the friction shoe and/or the cap to limit how far out of the housing the connecting member can be slid.

5. The headphone of claim 1, wherein the cap has an exterior surface that is configured to engage an interior surface of the channel to stabilize movement of the connecting member relative to the housing.

6. The headphone of claim 5, wherein the exterior surface of the cap has an outer shape and/or a dimension that generally corresponds to a shape and/or inner dimension of the channel.

7. The headphone of claim 1, wherein the housing further comprises a slot that opens to the channel and an exterior of the housing.

8. The headphone of claim 7, wherein the at least one rail comprises a first rail disposed on a first side of the slot and a second rail disposed on an opposing second side of the slot.

9. The headphone of claim 8, wherein the first and second rails are on the exterior of the housing.

10. The headphone of claim 7, wherein a portion of the cap extends into the slot.

11. The headphone of claim 7, wherein a portion of the friction shoe extends into the slot.

12. The headphone of claim 7, wherein the friction shoe is connected to the cap by a fastener that extends through the slot.

13. The headphone of claim 12, wherein the fastener also connects to the connecting member.

14. The headphone of claim 1, wherein the friction shoe comprises a frame that is configured to press the friction pad against the at least one rail.

15. The headphone of claim 1, wherein the friction pad comprises at least one channel configured to receive the at least one rail therein.

16. A headphone comprising:
a headband;
an earcup connected to a first end of the headband via a connecting member, a distal end of the connecting member having a cap; and
a slider mechanism configured to facilitate adjustment of the earcup relative to the headband, the slider mechanism comprising:
a housing comprising:
a channel extending therethrough between an upper end and a lower end thereof, the channel being configured to receive therein at least a portion of the connecting member, including the distal end and the cap;
a slot that opens to the channel and an exterior of the housing; and
first and second rail disposed on opposing sides of the slot; and
a friction shoe connected to the cap, the friction shoe comprising a friction pad that is configured to engage and move along the first and second rails, the engagement between the friction shoe and the first and second rails being configured to at least partially control movement of the connecting member relative to the housing.

17. The headphone of claim 16, wherein the friction shoe is disposed primarily outside of the housing.

18. A headphone comprising:
an earcup comprising:
a mounting portion having one or more connection elements and one or more alignment features; and
an ear receiving recess having a transducer output and an infrared sensor; and
an earcushion comprising:
a frame assembly having one or more connection elements and one or more alignment features; and
a mesh cage configured to nest within the ear receiving recess, the mesh cage having an aperture configured to aligned with the infrared sensor,
wherein the one or more connection elements and one or more alignment features of the mounting portion and the frame assembly are configured to allow for the earcushion to be connected to the earcup in only one orientation.

19. The headphone of claim 18, wherein the one or more connection elements of the mounting portion and the frame assembly:
comprise orientation specific connection components; and/or
are arranged in a non-symmetrical manner about a rotational axis.

20. The headphone of claim 18, wherein the one or more alignment features of the mounting portion and the frame assembly comprise a recess and a protrusion.
